(19) United States
(12) Patent Application Publication
(10) Pub. No.: US 2026/0063940 A1
(43) Pub. Date: Mar. 5, 2026

(54) DISPLAY DEVICE

(71) Applicant: Japan Display Inc., Tokyo (JP)

(72) Inventors: Yu-Sheng CHEN, Kaohsiung City (TW); Ming-Hsiang LEE, Kaohsiung City (TW); Chih Yueh TSAI, Kaohsiung City (TW); Chih Wei HSU, Kaohsiung City (TW); Chung Ting CHANG, Kaohsiung City (TW)

(21) Appl. No.: 19/312,734

(22) Filed: Aug. 28, 2025

(30) Foreign Application Priority Data
Aug. 29, 2024 (TW) 113132542

(51) Int. Cl. G02F 1/1333; G02F 1/133; G02F 1/1335; G02F 1/13357; H01Q 1/22; H01Q 1/38

(52) U.S. Cl. CPC G02F 1/133328; G02F 1/133603; H01Q 1/22; H01Q 1/38; G02F 1/13306; G02F 1/133305; G02F 1/133524; G02F 1/133605

(57) ABSTRACT

According to one embodiment, a display device includes a display module and a communication module arranged on a back side of the display module. The communication module includes a frame body, a sensing antenna, and a fixing unit. The frame body and the back side of the display module define a containing space together. The sensing antenna is located in the containing space. The fixing unit is arranged in the containing space and configured to fix the sensing antenna relative to the containing space.

### CROSS-REFERENCE TO RELATED APPLICATIONS

This application is based upon and claims the benefit of priority from Taiwanese Patent Application No. 113132542, filed Aug. 29, 2024, the entire contents of which are incorporated herein by reference.

### FIELD

Embodiments described herein relate generally to a display device, in particular to a display device with a sensing antenna.

### BACKGROUND

JP 2007-257483 A discloses a conventional display device, which has a read/write function of contactless IC card in addition to a display function, and includes a frame body, an LCD unit contained in the frame body, and a read/write unit formed by an antenna and other components, the read/write unit being arranged on a back side of the LCD unit opposite to a display area of the LCD unit.

However, the conventional display device does not have a structure for fixing the read/write unit. Therefore, if the conventional display device is used in a shaking or vibrating environment (e.g., a vehicle or a mobile card reader), the read/write unit may be easily shifted or damaged, thereby affecting the communication quality of the antenna. Furthermore, since the back side of the LCD unit does not have a structure for supporting the display unit, the display unit is prone to sag or shift over time, thereby affecting the display quality. This will reduce the reliability and durability of the conventional display device.

### BRIEF DESCRIPTION OF THE DRAWINGS

FIG. 1 is a schematic cross-sectional view illustrating a display device of an embodiment.

FIG. 2 is a schematic cross-sectional view illustrating a variation of the embodiment.

FIG. 3 is a schematic cross-sectional view illustrating another variation of the embodiment.

FIG. 4 is a schematic cross-sectional view illustrating yet another variation of the embodiment.

FIG. 5 is a schematic cross-sectional view illustrating a first variation of a fixing unit in the embodiment.

FIG. 6 is a schematic cross-sectional view illustrating a second variation of the fixing unit in the embodiment.

FIGS. 7A and 7B are schematic cross-sectional views illustrating two states of a third variation of the fixing unit of the embodiment.

FIGS. 8A and 8B are schematic top views illustrating two states of a fourth variation of the fixing unit of the embodiment.

FIGS. 9A to 9C are schematic top views illustrating three states of a fifth variation of the fixing unit of the embodiment.

FIG. 10 is a schematic top view illustrating a communication module of the embodiment.

FIGS. 11A to 11C are schematic cross-sectional views illustrating a plurality of variations of the embodiment.

FIG. 12 is a schematic cross-sectional view illustrating still another variation of the embodiment.

### DETAILED DESCRIPTION

Here, an object of the embodiment is to provide a display device that can overcome at least one disadvantage of the prior art.

In general, according to one embodiment, a display device includes a display module and a communication module arranged on a back side of the display module. The communication module includes: a frame body, defining a containing space together with the back side of the display module; a sensing antenna, located in the containing space; and a fixing unit, arranged in the containing space and configured to fix the sensing antenna relative to the containing space.

Due to the arrangement of the fixing unit, the shift of the sensing antenna in the frame body, which leads to the deviation of a sensing position, can be avoided; and debris or particles caused by the friction between the sensing antenna and the back side of the display module or the frame body can be avoided. In this way, it can be ensured that the display device has good sensing or communication quality and durability.

The embodiment further provides a display device. The display device includes a display module and a communication module arranged on a back side of the display module. The communication module includes: a frame body, defining a containing space together with the back side of the display module; a sensing antenna, located in the containing space; and an insulating device, arranged in the containing space and abutted against the sensing antenna, a surface of a part of the communication module opposite to the display module being a flat surface.

The configuration of the flat surface can prevent the display module from being sunken and causing uneven display brightness, thereby affecting the display quality of the display device.

Before the embodiment is described in detail, it should be noted that the accompanying drawings mentioned in the following description only illustrate the basic idea of the embodiment in a schematic manner, so that only the components related to the embodiment are displayed in the accompanying drawings and are not drawn according to the number, shapes and sizes of the components at the time of actual implementation; and the state, number and proportion of each component can be changed during actual implementation, and the layout form may also be more complex.

The display device of the embodiment is adapted to sense signals emitted by mobile devices (e.g., smart phones, electronic watches and other wearable devices, tablet computers, and IC cards) and can display the signals.

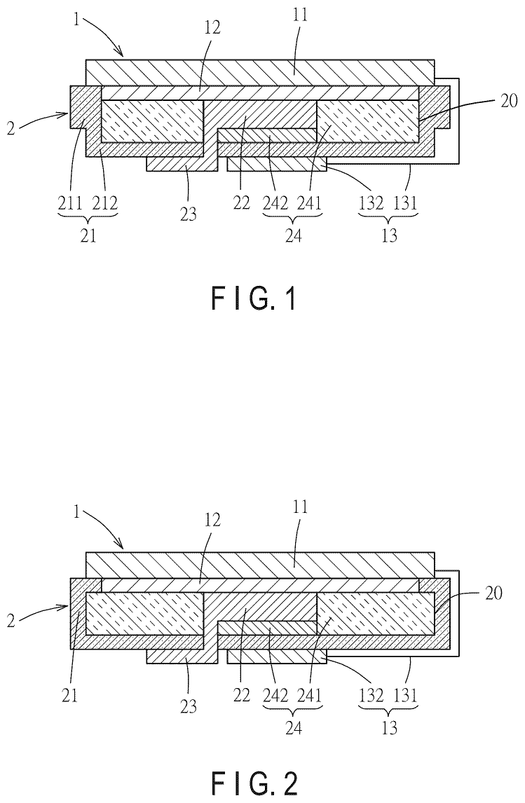

Referring to FIG. 1, the display device of a first embodiment includes a display module 1 and a communication module 2, the display module 1 having opposite front and back sides, the front side being configured for a display purpose, and the communication module 2 being arranged on the back side of the display module 1.

In the present embodiment, the display module 1 is a liquid crystal display (LCD), and includes an LCD panel 11, a backlight unit 12 arranged on a back side of the LCD panel 11, and a control unit 13, but the embodiment is not limited thereto. In other embodiments, the display module 1 may also be an organic light emitting diode (OLED) display or a light emitting diode (LED) display, etc.

The liquid crystal panel 11 may be a twisted nematic (TN) LCD panel, a multi-domain vertical alignment (MVA) LCD panel, an in-plane switching (IPS) LCD panel, or a fringe field switching (FFS) LCD panel, or other types of LCD panels.

The backlight unit 12 includes a light source, a light guide mechanism, and a reflective sheet. The light source is arranged on one side of the light guide mechanism. The light guide mechanism may include an optical film, and a light guide plate configured to guide light emitted by the light source to the LCD panel 11, such that the light emitted by the light source is uniformized to form a surface light source. The reflective sheet is arranged on a back side of the light guide plate opposite to the LCD panel 11 to reflect the light emitted from the back side of the light guide plate toward the LCD panel 11, thereby improving the luminous efficiency of the backlight unit 12. It should be noted that when the display module 1 is an OLED display or an LED display having a self-luminous property, the display module 1 is not provided with the backlight unit 12.

The control unit 13 is electrically connected to a trace in the LCD panel 11, can drive and control the display of the LCD panel 11, and includes a flexible substrate 131 electrically connected to a scan line and a data line, etc. of the LCD panel 11, and a control circuit board 132 electrically connected to a trace in the flexible substrate 131. In the present embodiment, the flexible substrate 131 is a flexible printed circuit (FPC) board, and the control circuit board 132 is a printed circuit board (PCB), but the embodiment is not limited thereto.

It should be noted that the LCD panel 11, the backlight unit 12, and the control unit 13 are the prior arts and are not within the scope of the present invention. The more detailed structures and operating principles of these components will not be further described herein.

The communication module 2 is configured to sense and read a signal emitted by a mobile device. In another embodiment, the communication module 2 may also have a function of writing information into the mobile device. In the present embodiment, the communication module 2 includes a frame body 21, a sensing antenna 22, a reader unit 23, and a fixing unit 24.

The frame body 21 is configured to surround the periphery of the backlight unit 12 of the display module 1, and defines a containing space 20 together with the back side of the display module 1. In the present embodiment, the frame body 21 is made of a metal material (e.g., aluminum), but the embodiment is not limited thereto. In other implementation modes, the frame body 21 may also be made of other materials (e.g., plastic).

In the present embodiment, the frame body 21 includes an outer frame portion 211 surrounding the periphery of the backlight unit 12, and a protruding portion 212 protruding relative to the outer frame portion 211 in a direction away from the display module 1. The outer frame portion 211 is located outside the protruding portion 212 and surrounds the protruding portion 212. The containing space 20 is defined together by the protruding portion 212 and the back side of the display module 1, but the embodiment is not limited thereto.

In a variation as shown in FIG. 2, the frame body 21 may not include the protruding portion 212. That is, in the embodiment, the containing space 20 is defined between the frame body 21 and the back side of the display module 1.

The sensing antenna 22 is located in the containing space 20 and can receive a signal emitted by the mobile device. The sensing antenna 22 may communicate with the mobile device via, for example, near-field communication (NFC), WiFi, or Bluetooth. The mobile device may be, for example, a smart phone with an NFC function, a tablet computer with an NFC function, or an IC card using a radio frequency identification (RFID) technology, etc.

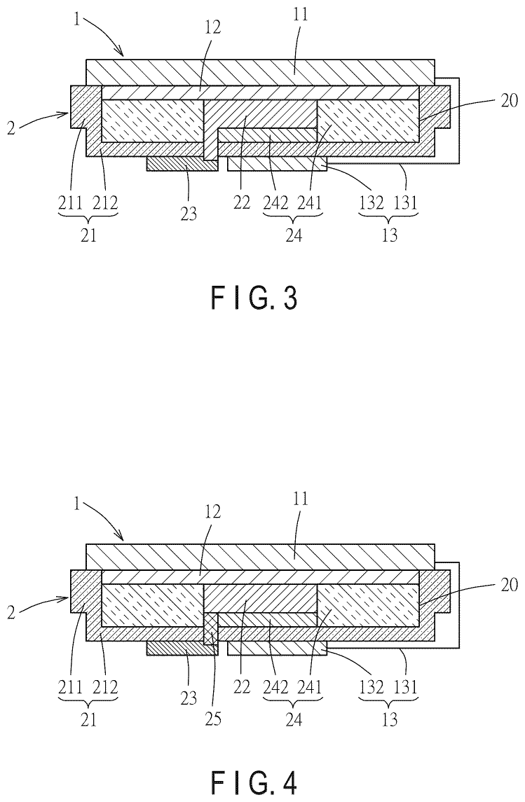

It should be noted that a projection shape or a projection area of the protruding portion 212 in a top-view direction (a vertical direction facing the front of the display module 1, i.e., a direction from top to bottom in FIG. 1) can be changed as needed. For example, the projection area of the protruding portion 212 may be equal to, greater than, or even much greater than the projection area of the sensing antenna 22. When a proportion of the projection area relative to the frame body 21 is increased, a larger containing space 20 can be provided, thereby providing the freedom of setting the sensing antenna 22 and providing enough space to contain a plurality of sensing antennas 22. In the present embodiment, the length and width of the sensing antenna 22 are 60 mm and 40 mm, respectively, while the projection area of the protruding portion 212 is much greater than the projection area of the sensing antenna 22, but the embodiment is not limited thereto. The reader unit 23 and the sensing antenna 22 are respectively arranged on opposite sides (i.e., the reader unit 23 is arranged on the back side of the frame body 21 and outside the containing space) of the frame body 21, and electrically connected to the sensing antenna 22. The reader unit 23 includes a reader circuit substrate capable of reading a signal received by the sensing antenna 22. In the present embodiment, as shown in FIG. 1, the reader unit 23 and the sensing antenna 22 are formed on the same flexible printed circuit board and electrically connected to each other, and a part of the flexible printed circuit board passes through the frame body 21. In a variation as shown in FIG. 3, the reader unit 23 is formed on a printed circuit board and electrically connected to the sensing antenna 22 (e.g., via wire bonding or a connector). Moreover, in another variation as shown in FIG. 4, the sensing antenna 22 is formed on a flexible printed circuit board, the reader unit 23 is formed on a printed circuit board, and the printed circuit board and the flexible printed circuit board are electrically connected via a connection line 25 that passes through the frame body 21, the connection line 25 being a signal transmission line, such as a coaxial cable. In another implementation mode, the reader unit 23 may also have a function of writing information into the mobile device.

The fixing unit 24 is arranged in the containing space 20 and configured to fix the sensing antenna 22 relative to the containing space 20. In the present embodiment, as shown in FIG. 1 and FIG. 10 (the display module 1 is not shown in FIG. 10), the fixing unit 24 includes an insulating device 241 abutted against the sensing antenna 22, and a sheet material 242 fixed to the frame body 21 and allowing the sensing antenna 22 to be attached. Specifically, the insulating device 241 is fixed to the back side of the frame body 21 or the display module 1 and configured to fix the sensing antenna 22 in a surrounding and abutting manner. The insulating device 241 is made of a non-metallic material such as an optical sheet, a silicone sheet, or foams. The sheet material 242 is a ferrite sheet located between the sensing antenna 22 and the frame body 21, but the embodiment is not limited thereto. In other implementation modes, the sheet material 242 may also be, for example, a double-sided tape, or a combination of a ferrite sheet and a double-sided tape. Furthermore, in the present embodiment, in a top-view direction, a projection area of the ferrite sheet on a reference plane is equal to a projection area of the sensing antenna 22 on the reference plane; and the insulating device 241 includes an insulating member, which is provided with a hollow portion for allowing the sensing antenna 22 to be appropriately accommodated therein to substantially fill a part of the containing space 20, that is not occupied by the sensing antenna 22 and the sheet material 242, so that a surface of the part of the communication module 2 opposite to the display module 1 becomes a flat surface. That is, the surface of the sensing antenna 22 attached to the back side of the display module 1 and the surface of the insulating member attached to the back side of the display module 1 form a coplanar surface, thereby avoiding the problem of uneven display brightness caused by the display module 1 being sunken, and further affecting the display quality of the display device of the embodiment.

It should be noted that, in the present embodiment, the display module 1 and the communication module 2 can both be connected to a device (e.g., a computer) having a signal receiving or processing function. Specifically, the above device can receive and process a signal read by the reader unit 23 of the communication module 2, then transmit the processed signal to the display module 1, and display relevant information through the display module 1, but the embodiment is not limited thereto.

Several variations of the fixing unit 24 will be described below.

In the first variation as shown in FIG. 5, the fixing unit 24 includes an insulating device 241 abutted against the sensing antenna 22, but no sheet material 242 is provided.

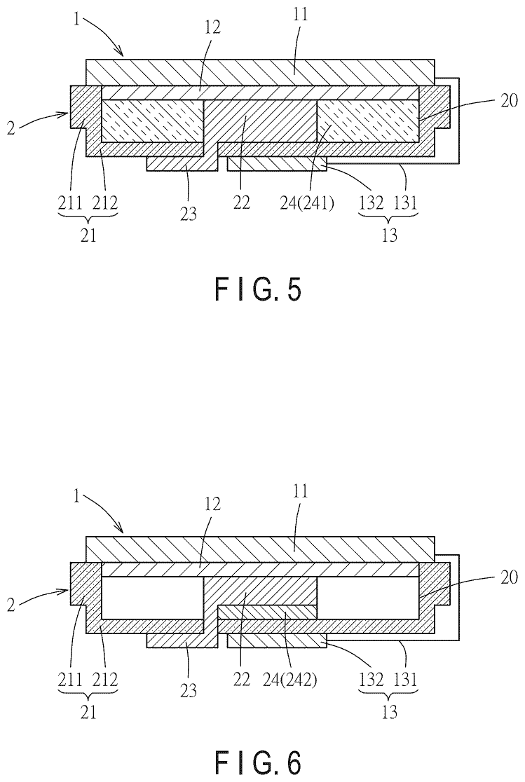

In the second variation as shown in FIG. 6, the fixing unit 24 includes a sheet material 242 fixed to the frame body 21 and allowing the sensing antenna 22 to be attached, but no insulating device 241 is provided. The sheet material 242 is a ferrite sheet located between the sensing antenna 22 and the frame body 21, and a projection area of the ferrite sheet is equal to a projection area of the sensing antenna 22.

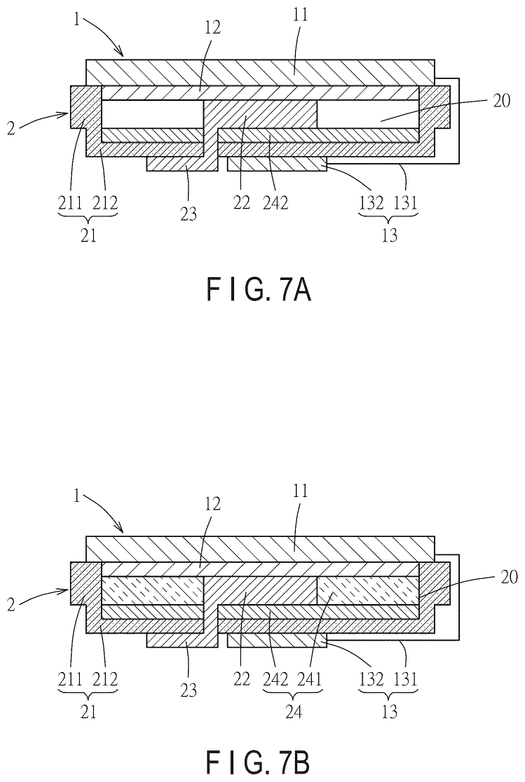

In the third variation as shown in FIG. 7A and FIG. 7B, the projection area of the ferrite sheet is greater than the projection area of the sensing antenna 22, which can more effectively suppress a signal interference of the frame body 21 made of metal or other external members on the sensing antenna 22. Therefore, by ensuring that the projection area of the ferrite sheet is equal to or greater than the projection area of the sensing antenna 22, the communication quality of the communication module 2 can be effectively improved to enhance the reliability of the display device of the embodiment. Here, FIG. 7A shows a state where the fixing unit 24 only includes the sheet material 242 (i.e., the ferrite sheet); and FIG. 7B shows a state where the fixing unit 24 includes the insulating device 241 and the sheet material 242.

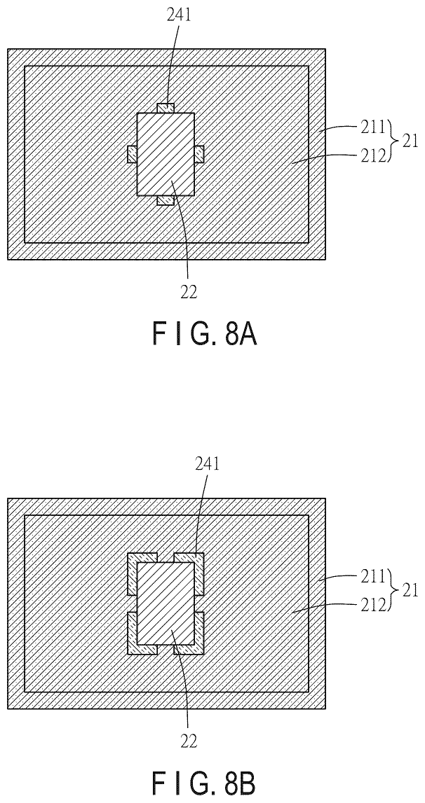

In the fourth variation as shown in FIGS. 8A and 8B, the insulating device 241 of the fixing unit 24 includes four insulating members, while the four insulating members are arranged around the sensing antenna 22, and respectively abutted against the four sides or four corners of the sensing antenna 22, so as to fix the sensing antenna 22 in a manner of surrounding and abutting against the sensing antenna 22. Here, FIG. 8A shows a state where the four insulating members of the insulating device 241 are respectively abutted against the four sides of the sensing antenna 22; and FIG. 8B shows a state where the four insulating members of the insulating device 241 are respectively abutted against the four corners of the sensing antenna 22.

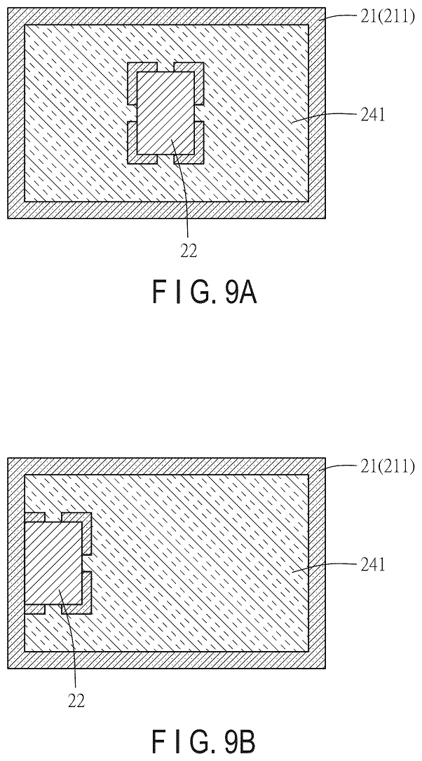

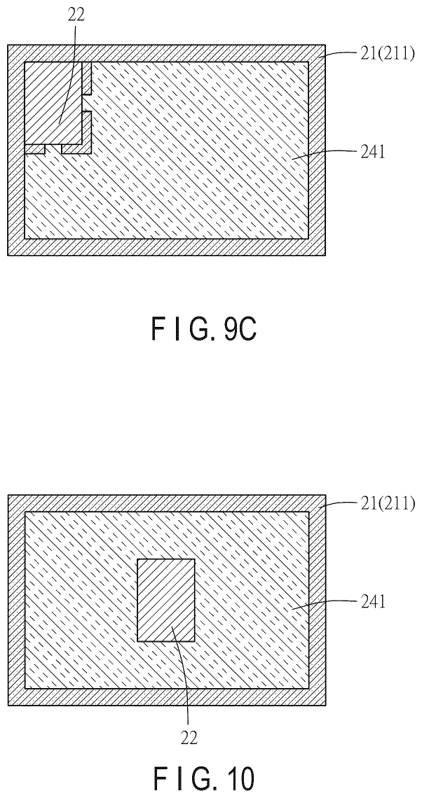

In the fifth variation as shown in FIG. 9A, an insulating member of the insulating device 241 is provided with a hollow portion that is slightly larger than the sensing antenna 22 and accommodates the sensing antenna 22, and a plurality of protruding teeth that extend toward the sensing antenna 22 and are abutted against the sensing antenna 22. In other words, the protruding teeth are configured to fix the sensing antenna 22 in a manner of surrounding and abutting against the sensing antenna 22. Referring to FIG. 9A, the hollow portion is located in the middle of the insulating member, and the number of the protruding teeth is four, which are abutted against the four sides of the sensing antenna 22, respectively. Referring to FIG. 9B, the hollow portion is located at a side edge of the insulating member, and the number of the protruding teeth is three. The three protruding teeth and one side of the frame body 21 adjacent to the hollow portion are respectively abutted against the four sides of the sensing antenna 22 to fix the sensing antenna 22 together. Referring to FIG. 9C, the hollow portion is located at a corner of the insulating member, and the number of the protruding teeth is two. The two protruding teeth and two sides of the frame body 21 adjacent to the hollow portion are respectively abutted against the four sides of the sensing antenna 22 to fix the sensing antenna 22 together. In other variations, the protruding teeth may also be configured to abut against the corners or other parts of the sensing antenna 22. It should be noted that when the insulating member is a sheet material and its hollow portion is located at an eccentric position, flipping the same insulating member can make it suitable for several different designs of arranging the sensing antenna 22 at different positions in the accommodating space 20.

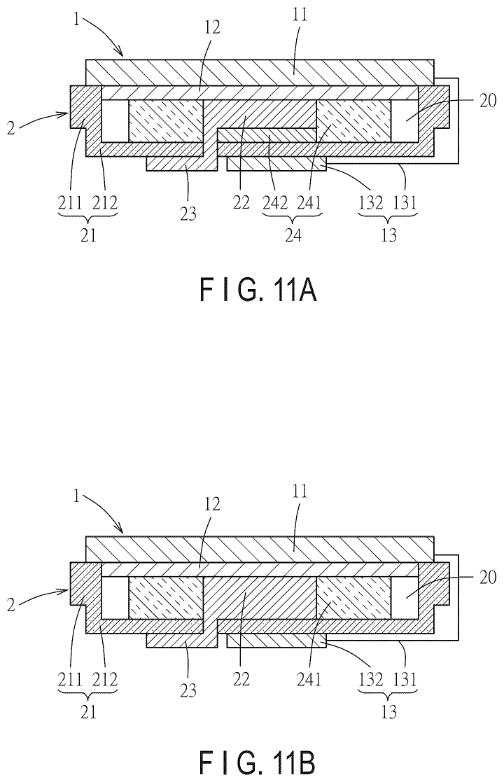

In the embodiment, the insulating device 241 is not limited to filling up the containing space 20. In the variations as shown in FIGS. 11A to 11C, the insulating device 241 may fix the sensing antenna 22 in a manner of not filling up the containing space 20. In a state of FIG. 11C, a surface of the part of the communication module 2 opposite to the display module 1 (i.e., a surface formed together by a surface of the sensing antenna 22 attached to the back side of the display module 1 and a surface of the insulating member attached to the back side of the display module 1) is a flat surface.

It should be noted that in the states as shown in FIGS. 6, 7A, 8A, 8B, 11A, and 11B, if the sensing antenna 22 is designed to be extremely thin, it can also prevent the display module 1 from being sunken and causing uneven display brightness.

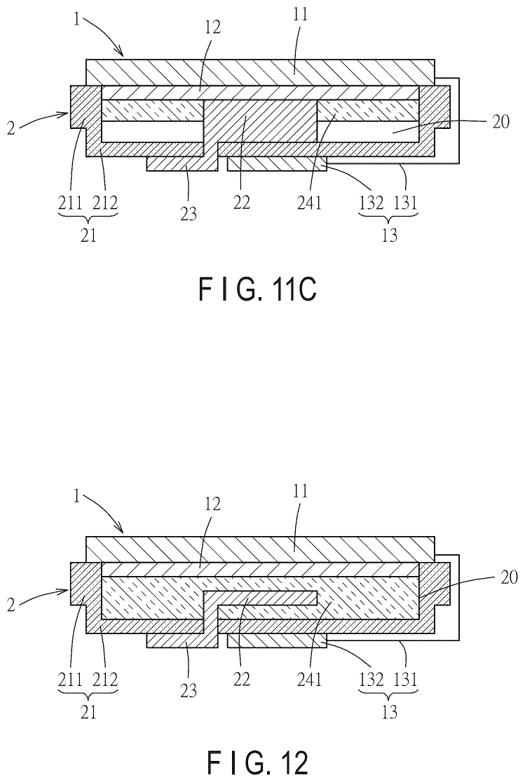

In another variation of the present embodiment as shown in FIG. 12, the insulating device 241 substantially covers the sensing antenna 22 from all sides, so that the flat surface of the communication module 2 opposite to the display module 1 is formed by the surface of the insulating device 241 attached to the back side of the display module 1. It should be noted that the in order to achieve the purpose of making the surface of the communication module 2 opposite to the display module 1 become a flat surface, it is not limited to the above-mentioned implementation modes. In another implementation mode, for example, a sheet material (e.g., a reflective sheet) can be attached to the surface of the communication module 2 facing the back side of the display module 1 to form the flat surface.

It is worth noting that when the LCD panel 11 of the display module 1 is an IPS LCD panel or an FFS LCD panel, a common electrode and a pixel electrode which is made of a transparent conductive material such as indium tin oxide (ITO) are both located on a thin film transistor array substrate, and there are a slit between the electrodes. Therefore, a transmission signal between the sensing antenna 22 and the mobile device can be partially transmitted through the display module 1 via the slit to the sensing antenna 22 or the mobile device.

It can be seen that when the LCD panel 11 is an IPS LCD panel or an FFS LCD panel, the display device of the embodiment can have a better viewing angle and better color reproduction, and can also have better communication quality. Furthermore, when the impedance of the common electrode of the LCD panel 11 is in the range of 500 to 2002, the shielding of the common electrode on the transmission signal can be reduced, thereby further improving the signal transmission efficiency of the display device of the embodiment.

Through the above description, the advantages of the display device of the embodiment can be summarized as follows:

I. Since the sensing antenna 22 is fixed by the fixing unit 24, the shift of the sensing antenna 22 in the frame body 21, which leads to the deviation of a sensing position, can be avoided; and debris or particles caused by the friction between the sensing antenna 22 and the back side of the display module 1 or the frame body 21 can be avoided. In this way, it can be ensured that the display device of the embodiment has good sensing or communication quality and durability. Therefore, even if the display device of the embodiment is in a shaking or vibrating environment, its communication function will not be affected.

II. By ensuring that the surface of the sensing antenna 22 and the insulating member in the communication module 2, which is opposite to the display module 1, is a flat surface, the display module 1 can be prevented from being sunken and causing uneven display brightness, thereby affecting the display quality of the display device of the embodiment. Therefore, even if the display device of the embodiment is in a shaking or vibrating environment, its display function will not be affected.

III. The ferrite sheet 242 is configured in such a way that its projection area in a top-view direction on the reference plane is equal to or greater than the projection area of the sensing antenna 22, which can effectively suppress a signal interference of the frame body 21 made of metal or other external members on the sensing antenna 22.

IV. By maximizing the containing space 20, the degree of freedom in the arrangement of the sensing antenna 22 can be ensured.

However, the above are only the embodiments of the embodiment, but the implementation scope of the present invention cannot be limited by these embodiments. All simple equivalent changes and modifications made in accordance with the application patent scope of the present invention and the contents of the patent specification are still within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device, comprising a display module and a communication module arranged on a back side of the display module,
the communication module comprises:
a frame body, defining a containing space together with the back side of the display module;
a sensing antenna, located in the containing space; and
a fixing unit, arranged in the containing space and configured to fix the sensing antenna relative to the containing space.

2. The display device of claim 1, the fixing unit comprises an insulating member fixed to the frame body and abutted against the sensing antenna.

3. The display device of claim 1, the fixing unit comprises a sheet material fixed to the frame body and allowing the sensing antenna to be attached.

4. The display device of claim 3, the sheet material is a ferrite sheet.

5. The display device of claim 1, the fixing unit substantially fills a part of the containing space that is not occupied by the sensing antenna.

6. The display device of claim 1, the frame body comprises a protruding portion, and the protruding portion and the back side of the display module together defines the containing space.

7. The display device of claim 1, the display module comprises an LCD panel and a backlight unit arranged on a back side of the LCD panel.

8. A display device, comprising a display module and a communication module arranged on a back side of the display module,
the communication module comprises:
a frame body, defining a containing space together with the back side of the display module;
a sensing antenna, located in the containing space; and
an insulating member, arranged in the containing space and abutted against the sensing antenna,
wherein a surface of a part of the communication module opposite to the display module is a flat surface.

9. The display device of claim 8, wherein
the flat surface is formed by a surface of the sensing antenna attached to the back side of the display module and a surface of the insulating member attached to the back side of the display module together.

10. The display device of claim 8, the display module comprises an LCD panel and a backlight unit arranged on a back side of the LCD panel.
